(19) United States
(12) Patent Application Publication
(10) Pub. No.: US 2022/0079160 A1
(43) Pub. Date: Mar. 17, 2022

(54) GREEN METHOD AND APPLICATION FOR INHIBITING TOXIN-PRODUCING ASPERGILLUS FLAVUS

(71) Applicant: OIL CROPS RESEARCH INSTITUTE, CHINESE ACADEMY OF AGRICULTURAL SCIENCES, Hubei (CN)

(72) Inventors: Jin MAO, Hubei (CN); Peiwu LI, Hubei (CN); Di SUN, Hubei (CN); Qi ZHANG, Hubei (CN); Wen ZHANG, Hubei (CN); Liangxiao ZHANG, Hubei (CN)

(73) Assignee: OIL CROPS RESEARCH INSTITUTE, CHINESE ACADEMY OF AGRICULTURAL SCIENCES, HUBEI (CN)

(21) Appl. No.: 17/475,370

(22) Filed: Sep. 15, 2021

(30) Foreign Application Priority Data
Sep. 15, 2020 (CN) 202010967118.7

(51) Int. Cl. A01N 59/16; A01N 25/12; A01P 3/00

(52) U.S. Cl. CPC A01N 59/16; A01P 3/00; A01N 25/12

(57) ABSTRACT

A green method and application for inhibiting toxin-producing Aspergillus flavus are provided. After a α-Fe₂O₃ nanorod nanomaterial is brought into contact with spores of toxin-producing Aspergillus flavus without germination or after germination for irradiation, under irradiation of a light source, inhibiting growth of the toxin-producing Aspergillus flavus to lower a content of aflatoxin. In the disclosure, the growth of hyphae and the germination of spores of the Aspergillus flavus may be effectively inhibited, the growth of the toxin-producing Aspergillus flavus may be inhibited, the pollution of agricultural products such as peanuts by the Aspergillus flavus may be effectively prevented, and the content of aflatoxin may be reduced, so that the disclosure has broad application prospects.

### CROSS-REFERENCE TO RELATED APPLICATION

This application claims the priority benefit of China Application No. 202010967118.7, filed on Sep. 15, 2020. The entirety of the above-mentioned patent application is hereby incorporated by reference herein and made a part of this specification.

### BACKGROUND

### Technical Field

The disclosure relates to a green method for preventing and treating agricultural product molds or food molds, and in particular, discloses a method and application for inhibiting toxin-producing Aspergillus flavus based on visible light catalysis technology.

### Description of Related Art

Aspergillus flavus is the most common soil saprophytic fungus in nature. Aspergillus flavus may contaminate crops such as peanuts, corn, cottonseeds, and related products, and among them, peanuts and corn may be easily infected by Aspergillus flavus. Aspergillus flavus may produce a variety of toxic secondary metabolites during the growth process, and the common ones mainly include aflatoxin B₁, aflatoxin B₂, aflatoxin G₁, aflatoxin G₂, etc., exhibiting strong carcinogenic, teratogenic, and mutagenic properties. Among them, the aflatoxin B₁ is the most toxic mycotoxin found so far and has been listed as a Class I carcinogen by the International Agency for Research on Cancer. The pollution caused by Aspergillus flavus and its toxin not only seriously threatens human health, but also causes huge economic losses. Therefore, the pollution prevention and treatment of Aspergillus flavus in peanuts and other agricultural products is of great significance.

The methods for preventing and treating flavus pollution mainly focus on biological, physical, and chemical methods. For instance, patent CN 108850003 B discloses a peanut antifungal agent and an antifungal method thereof. The main components of the antifungal agent are compound essential oil mixed with cinnamon essential oil, fennel essential oil, and oregano oil in according to a specific proportion. The compound essential oil may inhibit the growth of Aspergillus flavus. Further, patent CN 107142217 B discloses a biological pesticide. The mutant strain of Aspergillus flavus provided by this disclosure may compete with the toxin-producing Aspergillus flavus to reduce the pollution of toxin-producing Aspergillus flavus on agricultural products. Nevertheless, with the rise of high-quality development and industrial demand, it is of great significance to provide a green and highly-efficient method featuring low energy consumption to prevent and treat Aspergillus flavus pollution.

The photocatalytic technology is an economical, mild, and green technology with important application prospects in the fields of energy, environment, medicine, and agriculture. Moreover, researchers have carried out the application of photocatalytic technology in the sterilization or bacteriostasis of Escherichia coli, Staphylococcus aureus, and Aspergillus niger, but there are few reports on the prevention and treatment of fungi in agricultural and food products.

### SUMMARY

The purpose of the disclosure is to address the gap in the related art and thereby provides a green and efficient method and application for inhibiting toxin-producing Aspergillus flavus based on visible light catalysis technology, which can be used for the prevention and treatment of toxin-producing Aspergillus flavus.

To accomplish the foregoing purpose, the following technical solutions are adopted by the disclosure.

The disclosure provides a green method for inhibiting toxin-producing Aspergillus flavus. The green method includes the following steps. After a α-Fe₂O₃ nanorod photocatalytic material is brought into contact with spores of toxin-producing Aspergillus flavus without germination or after germination, inhibiting growth of the toxin-producing Aspergillus flavus to lower a content of aflatoxin under irradiation of a light source.

According to an embodiment of the disclosure, a length of each α-Fe₂O₃ nanorod is 50 nm-100 nm. According to an embodiment of the disclosure, the light source includes sunlight, a visible light source, a xenon lamp light source.

According to an embodiment of the disclosure, when the xenon lamp light source is applied, xenon lamp power is 150 W to 300 W, an illumination wavelength range is 420 nm to 700 nm, and a distance between a sample and the xenon lamp light source is 20 cm to 25 cm.

According to an embodiment of the disclosure, irradiation time of the light source is 4 hours-8 hours.

According to an embodiment of the disclosure, in a method for synthesizing the photocatalytic material and the α-Fe₂O₃ nanorod nanomaterial, an iron precursor and Na₂SO₄ are hydrothermally reacted to prepare uniform α-Fe₂O₃ nanorods, and hydrothermal reaction conditions are: reacting at 160° C.-180° C. for 12 hours-16 hours. To be specific, the iron precursor is FeCl₃.6H₂O. FeCl₃.6H₂O and Na₂SO₄ are added to deionized water, stirred evenly, and then transferred to a reactor with a polytetrafluoroethylene liner for hydrothermal reaction. The solid obtained after hydrothermal reaction is washed with absolute ethanol and water and then dried overnight.

According to an embodiment of the disclosure, a concentration ratio of FeCl₃.6H₂O to Na₂SO₄ is 1:1 to 1:1.2.

Based on the above, the bacteriostatic agent may be in a form of α-Fe₂O₃ powder, suspension, or α-Fe₂O₃ film dispersed on a carrier such as a non-metallic SiO₂ carrier.

The α-Fe₂O₃ nanorod photocatalytic material may also be used as a bacteriostatic agent for the prevention and treatment of toxin-producing Aspergillus flavus in peanuts to effectively reduce the content of aflatoxin in peanuts.

The disclosure further provides a green method for inhibiting toxin-producing Aspergillus flavus in agricultural products. The green method includes the following steps. A bacteriostatic α-Fe₂O₃ nanorod photocatalytic material is brought into contact with agricultural products containing toxin-producing Aspergillus flavus. The agricultural products containing toxin-producing Aspergillus flavus are treated under light to inhibit growth of the toxin-producing Aspergillus flavus. In this way, aflatoxin contamination may be lowered and quality and safety of the agricultural products are ensured.

In an embodiment of the disclosure, the agricultural products are peanuts and corn.

The disclosure further provides a green method for inhibiting Aspergillus flavus based on visible light catalysis technology. That is, a stable photocatalyst is prepared through a simple hydrothermal reaction, which may be used to inhibit growth of toxin-producing Aspergillus flavus in agricultural products such as peanuts under visible light irradiation. In this way, loss caused by toxin pollution may be reduced and quality and safety of agricultural products such as peanuts are ensured.

The technical solutions provided by the disclosure exhibit the following advantages.

1. In the method provided by the disclosure, sunlight and the like may be applied to provide a supervisable light source, so the method is green, requires low energy consumption, is pollution-free, and is scalable. The preparation method of the bacteriostatic agent is simple and requires low costs, and the bacteriostatic agent is recyclable and stable in performance.

2. In the disclosure, the growth of hyphae of the Aspergillus flavus and the germination of spores may be effectively inhibited, the growth of the toxin-producing Aspergillus flavus may be inhibited, the pollution of agricultural products such as peanuts by the Aspergillus flavus may be effectively prevented, and the content of aflatoxin may be reduced. The disclosure may be applied for green control of agricultural products or food molds, and therefore has broad application prospects.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a photo of a α-Fe₂O₃ nanomaterial which is prepared according to an embodiment of the disclosure.

FIG. 2a and FIG. 2b respectively are SEM and HRTEM images of the α-Fe₂O₃ nanomaterial according to an embodiment of the disclosure.

FIG. 3 is an XRD pattern of the α-Fe₂O₃ nanomaterial according to an embodiment of the disclosure.

FIG. 4 is an XPS pattern of the α-Fe₂O₃ nanomaterial according to an embodiment of the disclosure.

FIG. 5a to FIG. 5h are images showing inhibition of hyphae of toxin-producing Aspergillus flavus by α-Fe₂O₃ nanomaterials of different concentrations according to an embodiment of the disclosure.

FIG. 6a to FIG. 6h are images showing inhibition of spores of the toxin-producing Aspergillus flavus in an ungerminated period (a, b, c, and d) and a germination period (e, f, g, and h) by the α-Fe₂O₃ nanomaterial which is prepared according to an embodiment of the disclosure.

FIG. 7 is an image showing inhibition of the non-germinated spores of toxin-producing Aspergillus flavus under different time conditions under irradiation of a xenon lamp light source by the α-Fe₂O₃ nanomaterial which is prepared according to an embodiment of the disclosure.

FIG. 8a to FIG. 8d are images showing effects on inhibition of the toxin-producing Aspergillus flavus in peanuts by the α-Fe₂O₃ nanomaterial which is prepared according to an embodiment of the disclosure.

FIG. 9 is a chart showing contents of aflatoxin in peanuts treated with the α-Fe₂O₃ nanomaterial which is prepared according to an embodiment of the disclosure.

### DESCRIPTION OF THE EMBODIMENTS

The following describes the disclosure in further detail with reference to specific examples, but the methods and technical parameters involved in the solution cannot be understood as limitations to the disclosure.

### Example 1

Preparation of Photocatalytic Material

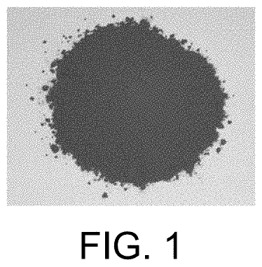

0.1 mol FeCl₃.6H₂O and 0.1 mol Na₂SO₄ were uniformly dispersed in 200 mL of deionized water. After ultrasonication, 160 mL of the above mixed solution was placed in a reactor with a polytetrafluoroethylene liner and reacted at 160° C. for 12 hours. The solid obtained after the hydrothermal reaction was washed 3 times with absolute ethanol and deionized water, and then dried at 60° C. overnight. After grinding, an iron oxide nanomaterial with visible light responsiveness was obtained (see FIG. 1).

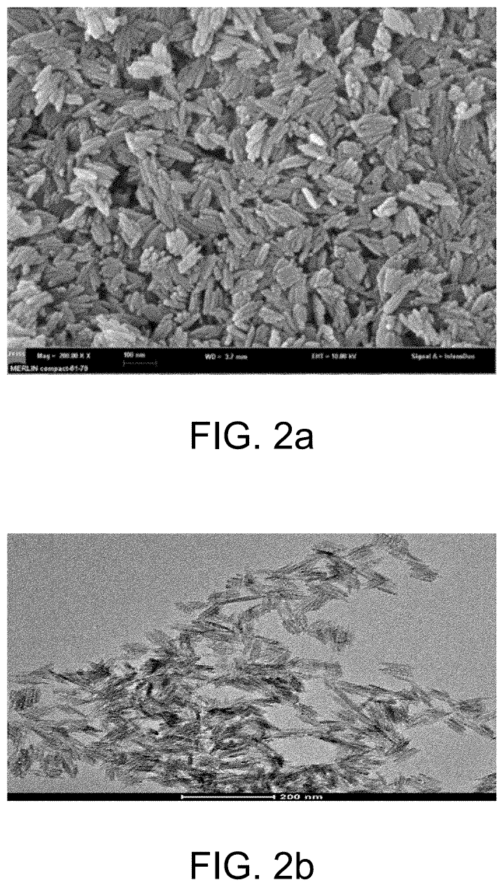

FIG. 2a and FIG. 2b respectively are SEM and HRTEM images of the α-Fe₂O₃ nanomaterial which is prepared according to an embodiment of the disclosure. It can be seen from the figures that the nano material is uniformly rod-shaped, with a length of 100-200 nm.

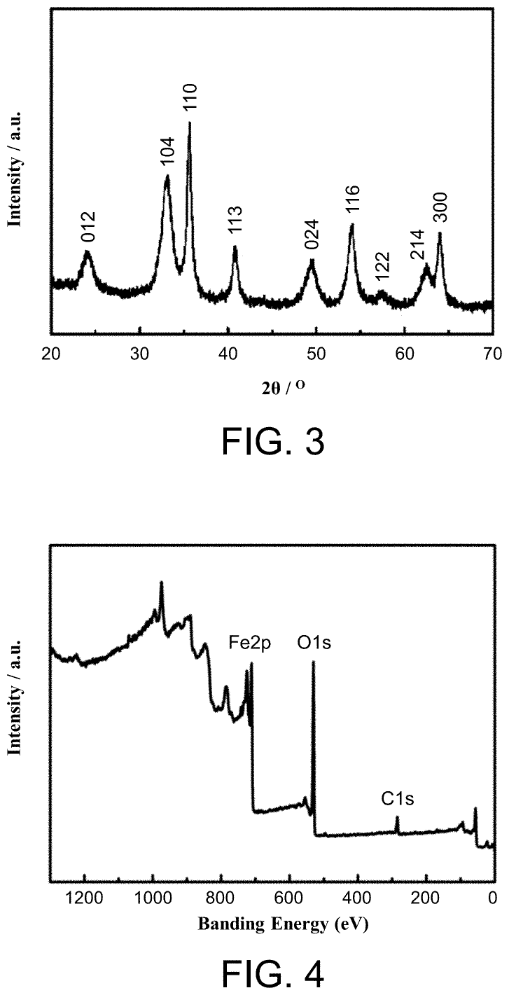

FIG. 3 is an XRD pattern of the α-Fe₂O₃ nanomaterial which is prepared according to an embodiment of the disclosure. It can be seen from the figure that the diffraction peaks of the prepared nanomaterial are consistent with the standard card JCPDS No. 01-089-0596.

FIG. 4 is an XPS pattern of the α-Fe₂O₃ nanomaterial according to an embodiment of the disclosure. It can be seen from the figure that the prepared nanomaterial is mainly composed of +3 valent iron elements and −2 valent oxygen elements.

### Example 2

Activation of Toxin-Producing Aspergillus Flavus

The spore solution of the preserved Aspergillus flavus (Aspergillus flavus 3.4408, purchased from the China Common Microbial Species Collection and Management Center) was inoculated on a sterile aspergillus agar basal (AFPA) growth medium and cultured in an incubator (28° C., 90% RH) for about 3 days until the bottom of Aspergillus flavus was orange and yellow.

Preparation of Spore Suspension

Aspergillus flavus hyphae were picked by sterile toothpicks, inoculated on a nitrosamine glycerin (DG 18) agar growth medium, and cultured in an incubator (28° C., 90% RH) for about 1 week. Spores of Aspergillus flavus were collected with sterile Tween-80 (0.1%), counted with a hemocytometer under an optical microscope, and stored in a refrigerator for later use.

Inhibition of Hyphae of Toxin-Producing Aspergillus Flavus

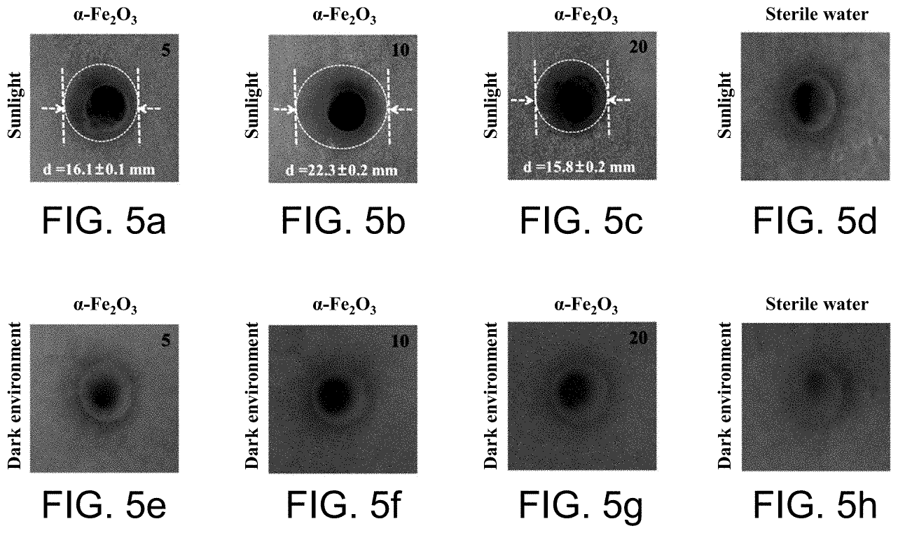

2 mL of the above spore suspension and 198 mL of potato dextrose agar (PDA) growth medium were evenly mixed and then were aliquoted into a sterile petri dish. When the growth medium has solidified, a hole was punched in the center of the dish. 100 μL of α-Fe₂O₃ (5, 10, and 20 mg mL⁻¹, respectively corresponding to FIG. 5a, FIG. 5b, and FIG. 5c) of different concentrations were added to the hole, placed in a dark environment for 30 minutes to reach adsorption equilibrium, and then placed under sunlight for treatment (the visible filter was used to control the wavelength range of 420 nm to 700 nm). The control group was treated with tin foil to avoid light, and the zone of inhibition was observed and recorded 7 hours later. As shown in FIG. 5d to FIG. 5h, there is no obvious zone of inhibition, where condition d is the presence of sunlight but no catalyst, conditions e, f, and g are the presence of catalyst but no light, and h is the condition that neither catalyst nor light exists. The results show that the catalyst and sunlight are indispensable, and their existence alone has almost no inhibitory effect on Aspergillus flavus. As shown in FIG. 5a to FIG. 5c, when the catalyst is excited by sunlight, it has a significant inhibitory effect on Aspergillus flavus. When the photocatalyst concentration is 10 mg mL⁻¹, the diameter of the zone of inhibition is 22.3±0.2 mm, and an optimal photocatalytic antibacterial effect is provided.

Repeatability and Stability Experiment

In order to prove the antibacterial stability of the photocatalytic material, four cycles of experiments were carried out in this research (Table 1). After the solar photocatalytic bacteriostasis experiment, the α-Fe₂O₃ was recovered by centrifugation, washed with deionized water and ethanol, dried at 80° C. for 3 hours, and then used again in the photocatalytic bacteriostasis experiment, and the experiment was repeated 4 times (photocatalyst concentration was 10 mg mL⁻¹). The results are shown in Table 1 below.

TABLE 1
repeated experiments of inhibition of toxin-producing Aspergillus flavus based on
recycled 4 rounds of α-Fe₂O₃ nanomaterials (zone of inhibition) in the disclosure

| | First round | Second round | Third round | Fourth round | Fifth round |
|---|---|---|---|---|---|
| Zone of | 22.3 ± 0.2 | 21.4 ± 0.14 | 23.2 ± 0.08 | 21.1 ± 0.13 | 22.2 ± 0.11 |
| inhibition (mm) | | | | | |

It can be seen from the experimental results that after being recycled 4 times, α-Fe₂O₃ still has strong antibacterial activity, the difference in sizes of the zones of inhibition is not obvious, and the performance is stable.

### Example 3

Evaluation of Inhibitory Effect of Ungerminated Spores of Toxin-Producing Aspergillus Flavus

100 μL of the above activated Aspergillus flavus solution and 0.1 g of the prepared α-Fe₂O₃ powder were placed in 9.9 mL of sterile water, and the mixture was stirred in a dark environment for 30 min until adsorption equilibrium was reached. The light/dark treatment method was the same as in Example 2, and the light was irradiated for 7 hours. 1.0 mL of the treated spore suspension was diluted with sterile water and spread on a malt extract agar (MEA) growth medium. After culturing at 28° C. for 24 to 28 hours, the number of colonies was recorded. Inhibition rate %=(number of colonies in the normal growth group−number of colonies in the experimental group)/number of colonies in the normal growth group×100%, where the normal growth group was under the conditions of no light and no bacteriostatic agent.

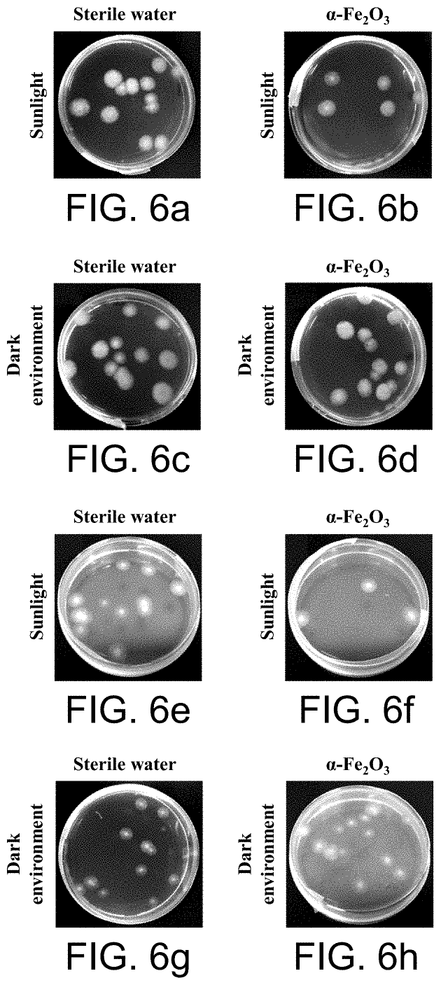

As shown in FIG. 6a to FIG. 6d, a is the condition of sunlight and no catalyst, b is the presence of both catalyst and sunlight, c is the absence of catalyst and light, and d is the presence of catalyst but no light. It can be seen from FIG. 6a and FIG. 6d that there is almost no difference in the number of colonies when only the catalyst or sunlight is used to treat the activated bacterial solution. In FIG. 6b, the number of colonies is obviously less, and the inhibition rate reaches 60%, indicating that α-Fe₂O₃ exhibits a good inhibition rate on ungerminated spores under sunlight.

Evaluation of inhibitory effect of spores of toxin-producing Aspergillus flavus during germination period:

The spores stored in the refrigerator in Example 2 were inoculated into a potato dextrose broth (PDB) growth medium and incubated for 8 hours to 9 hours to obtain spores of Aspergillus flavus at the germination period. 100 μL of the above germination spore suspension and 0.1 g of the prepared α-Fe₂O₃ powder were placed in 9.9 mL of sterile water, and the mixture was stirred in a dark environment for 30 min until the adsorption equilibrium was reached. The light/dark treatment method was the same as in Example 2. 1.0 mL of the treated spore suspension during the germination period was diluted with sterile water and spread on the malt extract agar (MEA) growth medium. After culturing at 28° C. for 24 to 28 hours, the number of colonies was recorded (FIG. 6e to FIG. 6h), where e is the condition of sunlight and no catalyst, f is the presence of both catalyst and sunlight, g is the absence of catalyst and light, and h is the presence of catalyst but no light. It can be seen from FIG. 6e, FIG. 6g, and FIG. 6h that there is no significant difference in the total number of colonies, indicating that light and catalyst are indispensable. It can be seen from FIG. 6f that under sunlight irradiation, α-Fe₂O₃ has a good antibacterial effect on the spores of Aspergillus flavus in the germination period, and the inhibition rate is >70%.

The above results show that this method has a good inhibitory effect on the spores of Aspergillus flavus that are not germinated and in the germination period and shows a higher inhibitory effect on the spores of Aspergillus flavus in the germination period, which may be due to the changes in the structure of the spore cells in the germination period and the reduced resistance to the external environment.

### Example 4

Evaluation of Inhibitory Effect of Ungerminated Spores of Toxin-Producing Aspergillus Flavus With Xenon Lamp as Light Source

100 μL of the above activated Aspergillus flavus solution and 0.1 g of the prepared α-Fe₂O₃ powder were placed in 9.9 mL of sterile water, and the mixture was stirred in a dark environment for 30 min until adsorption equilibrium was reached. A xenon lamp was used as the light source, xenon lamp power is 300 W, and a distance between a sample and the xenon lamp light source is 20 cm to 25 cm. A filter selected light in a range of 420 nm to 700 nm, the light/dark treatment method was the same as that in Example 2, and different irradiation time was applied. 1.0 mL of the treated spore suspension was diluted with sterile water and spread on a malt extract agar (MEA) growth medium. After culturing at 28° C. for 24 to 28 hours, the number of colonies was recorded. Inhibition rate %=(number of colonies in the normal growth group−number of colonies in the experimental group)/number of colonies in the normal growth group×100%, where the normal growth group was under the conditions of no light and no bacteriostatic agent.

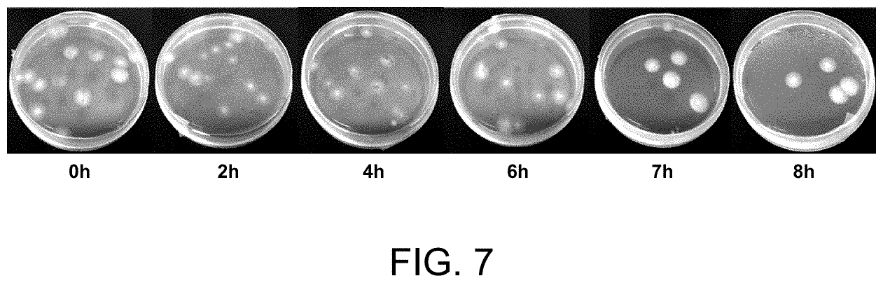

As shown in FIG. 7, under the irradiation of the xenon lamp light source, as the irradiation time is prolonged, the antibacterial effect improves, and the effect is the best in 7 hours, and after 8 hours, the effect is not much different from 7 hours. The reason is that the catalytic reaction may reach equilibrium, and therefore, the xenon lamp visible light irradiation for 7 hours exhibits a good inhibition rate for ungerminated spores.

### Example 5

Inhibition Experiment of Toxin-Producing Aspergillus Flavus in Peanuts

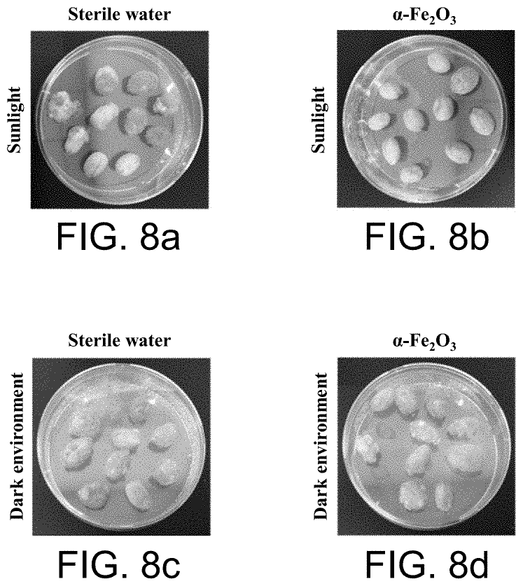

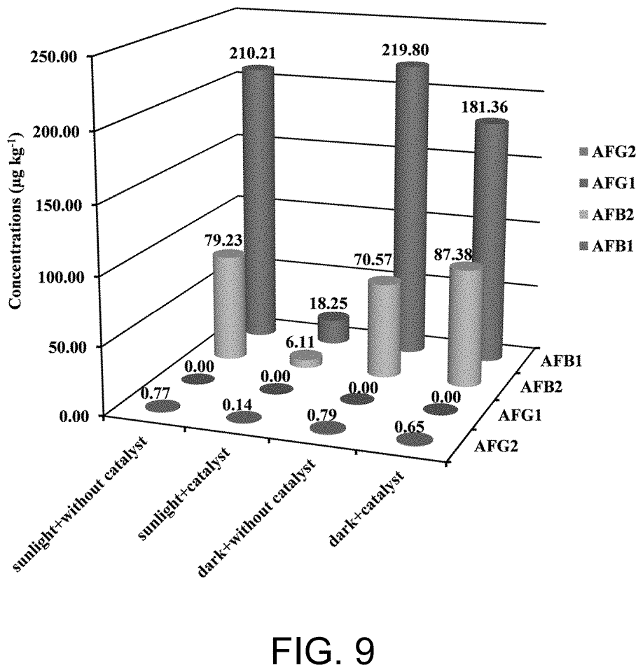

Intact peanut samples of a uniform size were collected and were divided into 4 groups evenly after sterilization (10 peanuts/group, approximately 5 g). The Aspergillus flavus spore suspension was inoculated on the surface of peanuts, and after natural drying, 100 mg of α-Fe₂O₃ powder was evenly sprinkled on the surface of peanuts. After 7 hours of sunlight treatment, the peanuts and α-Fe₂O₃ powder were separated with a sieve. The peanut samples were then cultured at 28° C. for 1 week, and the colony growth was observed. As shown in FIG. 8a, FIG. 8c, and FIG. 8d, the surface of peanuts was covered with gray-green spores to varying degrees, but in FIG. 8b, only a small amount of peanuts were infected, and the number of spores was small, proving that the Aspergillus flavus in peanuts may be effectively inhibited through this method. The peanuts cultured for 1 week were collected, sterilized (121° C., 30 min), and dried in an oven (80° C., 60 min). The dried peanut samples were crushed, 1.00 g of the peanut powder was weighed and extracted with methanol and then enriched with an immunoaffinity column, and the content of aflatoxin (AFB₁, AFB₂, AFG₁, and AFG₂) in the peanut samples was determined through high performance liquid chromatography (HPLC), as shown in FIG. 9. The results showed that the content of AFB₁ was the highest among all samples, but the content of AFB₁ treated with sunlight and α-Fe₂O₃ was only 1/10 of the other samples and was lower than the national limit standard (20 μg kg⁻¹). The above results indicate that the prepared α-Fe₂O₃ has the ability to inhibit the growth of Aspergillus flavus and may effectively reduce the pollution of aflatoxin under the sun.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A green method for inhibiting toxin-producing Aspergillus flavus, comprising: after bringing a α-Fe₂O₃ nanorod photocatalytic material into contact with spores of toxin-producing Aspergillus flavus without germination or after germination, inhibiting growth of the toxin-producing Aspergillus flavus to lower a content of aflatoxin under irradiation of a light source.

2. The green method according to claim 1, wherein a length of the α-Fe₂O₃ nanorod is 50 nm-100 nm.

3. The green method according to claim 1, wherein the light source comprises sunlight and a xenon lamp light source.

4. The green method according to claim 3, wherein irradiation time of the light source is 4 hours-8 hours.

5. The green method according to claim 3, wherein when the xenon lamp light source is applied, xenon lamp power is 150 W to 300 W, an illumination wavelength range is 420 nm to 700 nm, and a distance between a sample and the xenon lamp light source is 20 cm to 25 cm.

6. The green method according to claim 1, wherein in a method for synthesizing a nanomaterial of the α-Fe₂O₃ nanorod photocatalytic material, an iron precursor and Na₂SO₄ are hydrothermally reacted to prepare uniform α-Fe₂O₃ nanorods, and hydrothermal reaction conditions are: reacting at 160° C.-180° C. for 12 hours-16 hours.

7. The green method according to claim 6, wherein a concentration ratio of FeCl₃.6H₂O to Na₂SO₄ is 1:1 to 1:1.2.

8. The green method according to claim 1, wherein the bacteriostatic α-Fe₂O₃ nanorod photocatalytic material is used in a form of dispersing α-Fe₂O₃ powder, α-Fe₂O₃ suspension, or a α-Fe₂O₃ film on a carrier for use.

9. The green method according to claim 1, wherein irradiation time of the light source is 4 hours-8 hours.

10. A green method for inhibiting toxin-producing Aspergillus flavus in agricultural products, comprising: bringing a bacteriostatic α-Fe₂O₃ nanorod photocatalytic material into contact with agricultural products containing toxin-producing Aspergillus flavus and treating the agricultural products containing toxin-producing Aspergillus flavus under light to inhibit growth of the toxin-producing Aspergillus flavus to lower aflatoxin contamination.

11. The method according to claim 10, wherein the agricultural products are peanuts or corn.
